(19) United States
(12) Patent Application Publication
(10) Pub. No.: US 2026/0278512 A1
(43) Pub. Date: Sep. 17, 2026

(54) SYSTEM AND METHOD FOR GENERATING ACTIONABLE INSIGHTS DURING PROCESS ASSESSMENT

(71) Applicant: Accenture Global Solutions Limited, Dublin (IE)

(72) Inventors: Rajendra PRASAD TANNIRU, Basking Ridge, NJ (US); Koushik VIJAYARAGHAVAN, Chennai (IN); Mark Ogden GEORGE, Dallas, TX (US); Jason Michael DESS, Toronto (CA); Ram KRISHNAMOORTHY, Livingston, NJ (US); Sameep DESAI, Old Bridge, NJ (US); Arunachalam Venkatraman MANDAKOLATHUR, Chennai (IN); Siddharth Kaushik MEHTA, Parsippany, NJ (US); Neel PURANI, Edison, NJ (US); Ramprasadh VENKATACHLAM, Downingtown, PA (US)

(73) Assignee: Accenture Global Solutions Limited, Dublin (IE)

(21) Appl. No.: 19/076,318

(22) Filed: Mar. 11, 2025

(51) Int. Cl. G06Q 10/0637; G06Q 10/0639; G06Q 10/067

(52) U.S. Cl. CPC G06Q 10/0637; G06Q 10/06393; G06Q 10/067

(57) ABSTRACT

A system for generating one or more actionable insights, associated with process assessment is disclosed. The system comprises memory configured to store machine executable instructions and processor communicatively coupled with the memory. The system may aggregate data from a plurality of data-sources. The data associated is with one or more of process mining, market analysis capabilities, and/or process management. The system receives a user query, followed by generating, in response to the received user query, a digital twin model enabling visualization and simulation of organizational changes prior to implementation of the organizational changes. The system may receive further inputs for an adjustment or an optimization of the digital twin model, based upon simulation inputs for the organizational changes. Consequently, the system generates, based on the inputs for the adjustment or the optimization of the digital twin model, one or more actionable insights directed to improve efficiency or operational effectiveness.

### TECHNICAL FIELD

Various examples described herein relate generally to generating actionable insights during process assessment. Specifically, disclosed examples are directed to a system and a method for generating actionable insights by qualitative and quantitative analysis of data for activities associated with process assessment within organizations.

### BACKGROUND

Organizations across diverse sectors, including businesses and government entities, consistently strive for significant improvements in their operational performance. These improvements often encompass a range of objectives, such as rapidly introducing new products or services to the market to gain a competitive advantage, optimizing resource allocation and minimizing operational expenses, and achieving organizational goals with greater efficiency and effectiveness. The objectives are typically pursued with process assessment. The process assessment may refer to analysis and evaluation an organization's processes, thereby, identifying inefficiencies, bottlenecks, and potential areas for improvement by leveraging data analysis and pattern recognition capabilities, ultimately aiming to optimize workflows and decision-making within the organization.

However, many organizations encounter significant challenges in achieving these desired improvements. Furthermore, optimizing end-to-end outcomes presents significant challenges. Historically, organizations have relied on siloed systems and data, which impede collaboration and data sharing across departments. This lack of integrated information and cross-functional communication hinders the identification and resolution of systemic issues that impact overall performance.

Implementations of the present disclosure are generally directed to generating actionable insights during process assessment. More particularly, implementations of the present disclosure are directed to systems and methods for qualitative and quantitative analysis of data for the activities associated with process assessment, within organizations, using generative artificial intelligence (GenAI).

In general, innovative aspects of the subject matter described herein provide a system and a method for process assessment, performed by a system. The system may include one or more memory configured to store machine executable instructions and one or more processor communicatively coupled with the one or more memory and configured to execute the machine executable instructions. The system may aggregate data from a plurality of data-sources. The data may be associated with one or more of process mining, market analysis capabilities, and/or process management. The system may receive a user query to interact with the aggregated data. Further, the system may generate, in response to the received user query, a digital twin model enabling visualization and simulation of organizational changes prior to implementation of the organizational changes. Thereafter, based upon simulation inputs for the organizational changes, the system may receive further inputs for an adjustment or an optimization of the digital twin model. Consequently, the system may generate, based on the inputs for one of the adjustments and the optimization of by the digital twin model, one or more actionable insights directed to improve efficiency or operational effectiveness.

The present disclosure further describes a method for implementing the system provided herein. The present disclosure also describes non-transitory computer-readable media (CRM) coupled to one or more processors and having instructions stored thereon which, when executed by the one or more processors, cause the one or more processors to perform operations in accordance with the method described herein.

It is appreciated that systems in accordance with the present disclosure can include any combination of the aspects and features described herein. That is, the system in accordance with the present disclosure are not limited to the combinations of aspects and features specifically described herein, but also include any combination of the provided aspects and features.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 illustrates an example environment used to execute implementations of the present disclosure.

FIG. 2 illustrates an example architecture of the system for generating actionable insights during process assessment, in accordance with implementations of the present disclosure.

FIG. 3 illustrates a flow diagram of an example method implemented by the system for generating actionable insights during process assessment, in accordance with implementations of the present disclosure.

FIG. 4 illustrates an example computer system that may be used to implement the system for generating actionable insights during process assessment, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, “by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term "comprising" when utilized means "including, but not necessarily limited to"; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

The “lenses” represent different attributed through which organizational activities are analyzed. The lenses derive qualitative and quantitative insights from data for the activities that are under process assessment. Lenses are directional and when combined help identify opportunity themes.

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring details of the examples.

The specification and drawings are to be regarded in an illustrative rather than a restrictive sense. It will, however, be evident that various modifications and changes may be made thereunto without departing from the broader spirit and scope of the invention as set forth in the claims.

Organizational processes frequently diverge significantly from actual operational realities. Understanding this "as-is" state necessitates comprehensive data analysis. Traditional process assessment methodologies focus on optimizing individual elements such as operations, personnel, systems, and business units. This siloed approach, however, can lead to fragmented improvements with limited impact on overall performance. Furthermore, crucial factors such as system interdependencies, technological constraints, data availability, human capital, and skillsets are often overlooked, despite their significant influence on organizational outcomes. Optimizing a single function or process without considering its downstream implications can hinder progress and impede the achievement of desired end-to-end outcomes. Data silos and limited inter-departmental collaboration further exacerbate these challenges.

Moreover, the traditional methods of process assessment possess are unable to effectively integrate process mining data with existing process models, thus leading to fragmented view of the process, hindering comprehensive analysis and improvement. Traditional methods struggle to access and gather data at scale from multiple sources. This data scarcity restricts the scope and depth of analysis of organizational processes.

Thus, there is a need for effective analysis and improvement of organizational processes that require a holistic approach of process assessment that considers the interplay of all relevant factors and leverages integrated data sources to gain a comprehensive understanding of operational realities.

In view of this, in the present disclosure, a system and a method for process assessment, to overcome above mentioned drawbacks of the conventional methods of process assessment, are described. In the present disclosure, a system is disclosed to capturing and analyzing an organization's current operational state or processes by implementing qualitative and quantitative analysis of data for the activities associated with process assessment, within organization.

Furthermore, the proposed solution overcomes the limitations of traditional process assessment methodologies by integrating process mining with process modeling, facilitating data collection at scale, and incorporating real-time feedback from employees. Specifically, the proposed solution combines targeted process mining techniques with the digitization of both current state and desired future state. The integration provides a holistic view of the process, encompassing both the actual execution and the desired state. Additionally, the proposed solution facilitates the collection of a vast amount of data from various data sources, including process execution data, system logs, and employee surveys. The data richness enables more accurate and insightful analysis. Moreover, the proposed solution facilitates analytically determining and quantifying the complex interdependencies and relationships between processes, people, technology, and ultimately, the desired value outcomes. Furthermore, the proposed solution incorporates real-time feedback from surveys. The feedback, which includes data on time consumed, impediments, sentiment, and pain points, is attributed to specific activities within the process model, providing valuable insights.

In the present disclosure, includes aggregating diverse data sources, including client-specific data and industry-specific proprietary information. The aggregated data undergoes both quantitative and qualitative analysis. Specifically, multiple analytical lenses are applied to the data to gain different perspectives and insights. The lenses may refer to qualitative and quantitative analysis of processes across industries and functions, which offers and unique perspective on process efficiency and identifying areas for optimization. Generative AI (GenAI) is then employed to delve deeper into the analysis, extracting insights and identifying potential challenges and bottlenecks within the organization's operations. Herein, GenAI leverages the analyzed data and insights to generate potential recommendations for process improvement. In other words, GenAI, using lenses, may facilitate identifying areas for optimization, suggesting alternative approaches, and proposing innovative solutions. In essence, the present disclosure describes a data-driven approach to process assessment and improvement. Additionally, the system and method disclosed herein extend beyond traditional process analysis by encompassing a holistic view of the operating ecosystem. This encompasses not only end-to-end process analysis but also incorporates workforce analysis, including role-based responsibilities, time-on-task metrics, and associated costs. Furthermore, the disclosed system and method integrates technology landscape considerations into the analysis. A key feature of the proposed solution is the ability to analytically determine and quantify the complex interdependencies and relationships between processes, people, technology, and ultimately, the desired value outcomes.

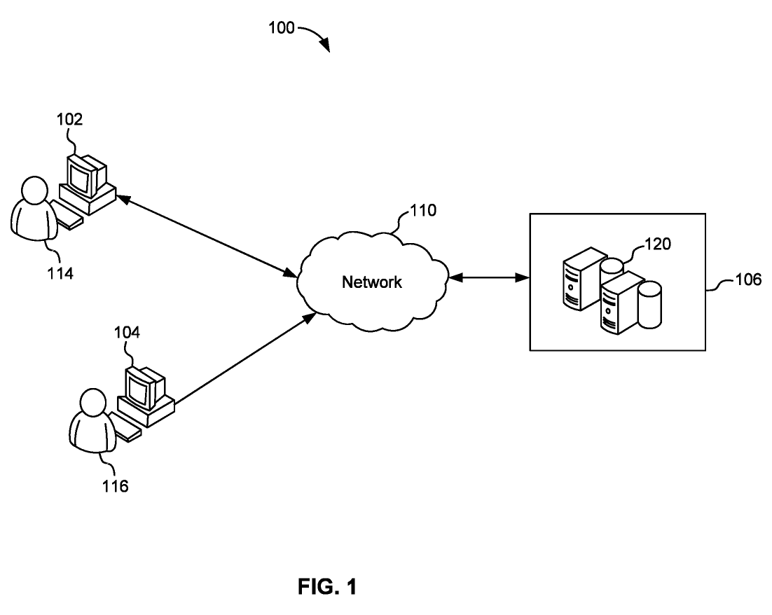

FIG. 1 depicts an example environment 100 that can be used to execute implementations of the present disclosure. In some examples, the example environment 100 enables users associated with respective systems to execute requests to generate one or more actionable insights by invoking a trained language model in accordance with implementations of the present disclosure. The example environment 100 includes computing devices 102 and 104, back-end system 106, and a network 110. In some examples, the computing devices 102 and 104 are used by respective users 114 and 116 to log into and interact with the back-end system 106 and applications executing on the back-end system 106 according to implementations of the present disclosure.

As shown in FIG. 1, the computing devices 102 and 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites (e.g., web applications executing on the back-end system 106), user devices (e.g., the computing devices 102, 104), and the back-end system 106. In some examples, the network 110 can be accessed over a wired and/or a wireless communications link. For example, mobile computing devices, such as smartphones can utilize a cellular network to access the network 110.

While only one back-end system 106 is shown in FIG. 1, there may be more than one back-end system 106, and each of the back-end systems 106 includes at least one server system 120. In some examples, the at least one server system 120 hosts one or more computer implemented services that users can interact with by using the computing devices 102 and/or 104. For example, components of enterprise systems and applications can be hosted on one or more of the back-end system 106. In some examples, the back-end system 106 can be provided as an on-premises system that is operated by an enterprise or a third-party taking part in cross-platform interactions and data management. In some examples, the back-end system 106 can be provided as an off-premises system (e.g., cloud or on-demand) that is operated by an enterprise or a third-party on behalf of an enterprise.

In some examples, each of the computing devices 102 and 104 includes computer executable applications executed thereon. In some examples, each of the computing devices 102 and 104 includes a web browser application executed thereon, which can be used to display one or more web pages of applications executing on the back-end system 106. In some examples, each of the computing devices 102 and 104 can display one or more graphical user interfaces (GUIs) that enable the respective users 114 and 116 to interact with the back-end system 106. In accordance with implementations of the present disclosure, the back-end system 106 may host enterprise applications or systems that require data sharing and/or data privacy. In some examples, the computing device 102 and/or the computing device 104 can communicate with the back-end system 106 over the network 110.

In some implementations, the back-end system 106 can be implemented in a cloud environment. The back-end system 106 includes at least one server system (or server) 120. In the example of FIG. 1, the back-end system 106 can include various forms of servers including, but not limited to, a web server, an application server, a proxy server, a network server, and/or a server pool. In general, server systems accept requests for application services and provide such services to any number of client devices (for example, the computing device 102 over the network 110).

In some implementations, the back-end system 106 may utilize artificial intelligence (AI) and a machine learning (ML) technique, to perform qualitative and quantitative analysis of data for the activities associated with process assessment.

Various examples, depicting generation of actionable insights during process assessment, within organization, are described in detail in conjunctions with figures below.

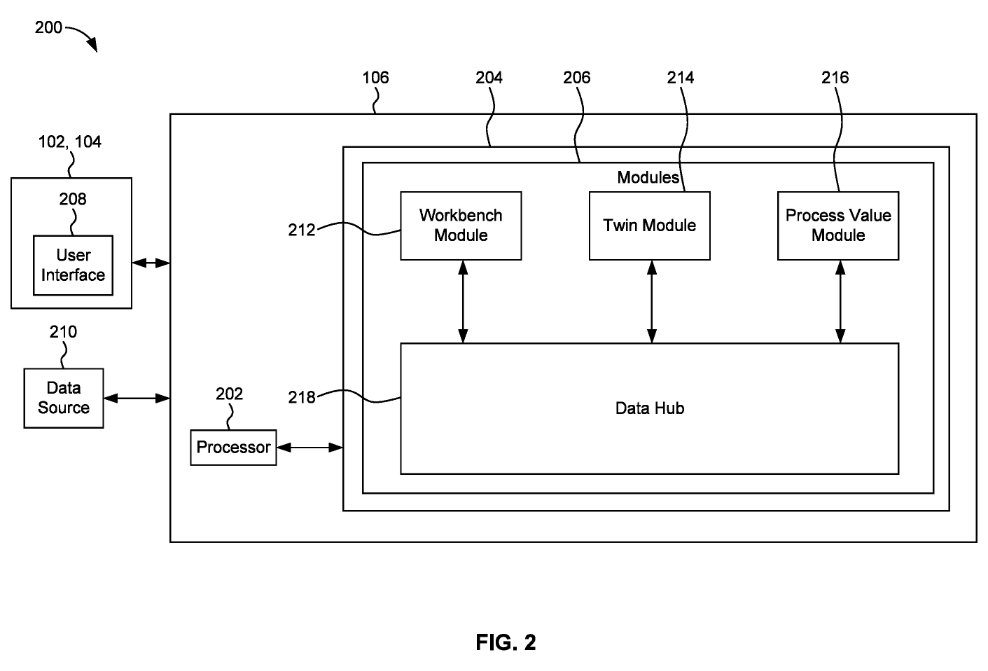

FIG. 2 illustrates an example architecture 200 of the system 106 for generating actionable insights during process assessment, in accordance with implementations of the present disclosure. The system 106 may include one or more memory 204 storing machine executable instructions and the one or more processors 202. The back-end system 106 may be communicably coupled to a data source 210 and the computing devices 102 and/or 104, including a user interface 208. The back-end system 106 may include one or more processors 202 communicably coupled with the one or more memory 204 and configured to execute the machine executable instructions. In some examples, the one or more processors 202 may include, but not limited to, microprocessors, microcomputers, hardware processors, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the one or more processors 202 may be programmed to cooperate with non-transitory computer-readable instructions stored in the one or more memory 204 (also referred to be as computer-readable medium) for performing operations according to the present disclosure. The one or more memory 204 may be non-transitory or non-volatile medium, such as a magnetic disk or solid-state non-volatile memory or volatile medium such as Random Access Memory (RAM), and/or the like.

In some examples, the one or more memory 204 may include plurality of modules 206. The plurality of modules 206 may further include a workbench module 212, a twin module 214, a process value module 216 and a data hub 218.

In some examples, the system 106 may aggregate data from the data source 210. The data may be associated with one or more of process mining, market analysis capabilities, and/or process management) The data source 210 may include a plurality of data-sources, said data sources may specialize in collecting different types of data related to business operations. The system 106 may utilize an application programming interface (API) to programmatically access and retrieve data stored in the data source 210 and consolidate data from a diverse range of external platforms. Herein, the process mining data may include data related to the actual execution of processes. For instance, the process miming data may include event logs, which record timestamps and attributes of events occurring within a process (for example, start/end times of tasks, resource assignments, case IDs). The market analysis capabilities data may include data pertaining to market trends, customer behavior, competitor activities, and other market-related factors. For example, market analysis capabilities data may include, but not limited to, market research data, customer relationship management (CRM) data, sales data, and competitive intelligence. The process management data may include data related to the design, execution, monitoring, and optimization of processes. For example, the process management data may include, but not limited to process models (e.g., process model and notation (PMN) diagrams), process definitions, key performance indicators (KPIs), resource allocation data, and information about process changes and improvements. In essence, the data described may encompass information related to the actual execution of processes, market dynamics, and the management of processes. The data may be utilized for gaining a comprehensive understanding of organizational performance and identifying areas for improvement further.

The plurality of modules 206 may receive the aggregated data for further processing. Specifically, the workbench module 212 may further, receive a user query, via a user interface 208, to interact with the aggregated data from the data source 210. The user query may be associated for data exploration and process management. Further, the user query may be a natural language processing query and associated with data exploration and process management. Herein the process management may include a structure, performance, and a bottleneck of a process.

The workbench module 212 may serve as the operational hub where users may interact with the back-end system 106, enabling access to various functionalities for optimizing processes. Users may submit queries to explore the aggregated data, analyze processes, and initiate specific analyses. Specifically, the workbench module 212 may serves as the entry point for various process management activities. The process management activities may include, but not limited to, process design and modeling, process simulation and analysis, process monitoring and control and process improvement. Specifically, process design and modeling may imply that the users may create and modify process models (for example, process model and notation PMN diagrams, a visual representation of a process) within the workbench module 212. The process monitoring and control may imply that the users can monitor the execution of live processes, identify deviations from expected behavior, and take corrective actions. The process improvement may imply that the workbench module 212 may provide tools and techniques for identifying and implementing process improvements, such as bottleneck analysis, root cause analysis, and scenario planning. The workbench module 212 may implement pain point categorization and sentiment analysis. Herein, the pain point categorization may refer to the process of classifying and grouping pain points encountered during various activities or processes. Further, a structured system for classifying pain points into different categories, such as technical issues, communication problems, resource constraints, and human factors. Thereafter, techniques such as NLP may be utilized to analyze unstructured text data (for example, employee surveys, customer feedback, incident reports, or the like) to automatically categorize and tag pain points based on respective descriptions. The sentiment analysis may refer to analyzing text data to determine the context/sentiment expressed. Specifically, said sentiment analysis may include determining whether the sentiment expressed in the text is positive, negative, or neutral. After that, the intensity of sentiment may be measured, that is, the strength of the positive or negative sentiment may be determined. Consequently, specific context may be recognized and classified. In essence, the workbench module 212 may facilitate data visualization capabilities to effectively communicate insights and trends from the aggregated data.

In response to the received user query, the twin module 214 may generate a digital twin model enabling visualization and simulation of organizational changes prior to implementation of the organizational changes. The digital twin model may refer to a virtual replica of the organization's operations, incorporating data from various data sources, thereby enabling users to visualize and simulate organizational changes before implementation. Moreover, based upon simulation inputs for the organizational changes the twin module 214 may receive further inputs for an adjustment or an optimization of the digital twin model, based upon simulation inputs for the organizational changes. For example, if said simulations show that a particular department is consistently overloaded, the user may input adjustments to resource allocation, such as adding staff or redistributing workloads. In another example, if simulations are based on certain market assumptions, the user may adjust market parameters, such as demand forecasts, competitor behavior, or pricing strategies, to evaluate the model's sensitivity to changes in the external environment. The digital twin model may include data aggregated from the data source 210, including process mining data, market analysis data, and operational data. The aggregated data may be used to create a realistic and accurate representation of the organization. The core functionality of the digital twin may its ability to simulate organizational changes. The twin module 214 may enable users to input hypothetical changes to processes, structures, or strategies into the digital twin model and observe the potential outcomes. The simulations may predict the impact of changes on performance, efficiency, and other key metrics. Specifically, the digital twin model may analyze historical and real-time data from various data sources, such as process mining data, market analysis data, and operational data, thereby, identify key metrics relevant to the organization. Furthermore, the digital twin model may incorporate process models that represent the organization's workflows and activities. The process models may be used to simulate the flow of work and predict how changes may impact process efficiency and throughput. In an example, the digital twin model may utilize simulation techniques that take into account factors, such as resource availability, processing times, and dependencies between activities. The techniques may facilitate prediction about changes to said factors may affect overall performance and efficiency. Further, the digital twin model may utilize statistical analysis techniques to forecast the impact of changes on key metrics. For instance, the digital twin model may utilize historical data to identify trends and patterns. The digital twin model may utilize machine learning models to learn from historical data and improve predictive capabilities over time. This may include using machine learning to identify patterns, predict future outcomes, or optimize decision-making based on various scenarios.

Moreover, the digital twin model may provide visual representations of the organization's operations, such as process flow diagrams, dashboards, and three-dimensional (3D) visualizations. The 3D visualizations may enable users to determine complex systems and identify potential bottlenecks or areas for improvement. The digital twin model may prompt and receive user input about a plurality of factors. The users may provide text-based responses to questions, enter data, or describe their assumptions. The users may enter numerical values for parameters, such as resource allocation, demand forecasts, or cost estimates. Moreover, users may utilize graphical interfaces for dragging and dropping elements, adjusting parameters on charts, or drawing diagrams. Further, the digital twin model may weigh, using an autonomy algorithm, the plurality of factors including a task priority, past interactions, and/or real-time context. The autonomy algorithm may refer to a technique enabling the digital twin model to assess and prioritize various factors to determine the best course of action. The autonomy algorithm may implement machine learning techniques, such as reinforcement learning, to learn and adapt the decision-making behavior based on past experiences and feedback. The task priority may include considering the relative importance of different tasks or objectives by utilizing the autonomy algorithm. The higher priority tasks will receive greater weight in the decision-making process. The past interactions may include analyzing historical data and user interactions. For instance, past decisions, their outcomes, and user preferences. By learning from past experiences, the autonomy algorithm may facilitate making informed decisions in the future. The real-time context may include continuous monitoring and incorporation of real-time information, such as current system status, resource availability, and external events. Thus, the digital twin model may adapt to changing conditions and make dynamic decisions.

Further, the process value module 216 may generate one or more actionable insights directed to improve efficiency or operational effectiveness, based on the inputs for the adjustment or the optimization of the digital twin model. The one or more actionable insights may include process management insights, an operating model, an organizational design, a market analysis, and a spend analysis. Herein, the process management insights may refer to recommendations for improving processes. The process management insights may identify bottlenecks, suggest process re-engineering opportunities, and recommend changes to process workflows. The operating model may generate insights into the optimal operating model for the organization. Herein, the optimal operating model may refer to the most effective and efficient organizational structure and processes for achieving the organization's strategic goals. The operating model may further include recommendations on organizational structure, resource allocation, and key performance indicators (KPIs). The organizational design may provide insights into how to optimize the organizational structure for improved efficiency and effectiveness. The organizational design may further include recommendations on team structures, reporting lines, and skill development. The market analysis may generate insights into market trends, customer behavior, and competitive landscapes. The market analysis may refer to information used to inform strategic decisions and optimize business operations. The spend analysis may include analyzing spending patterns and identify areas for cost optimization. The spend analysis may further include identifying inefficiencies in procurement processes, negotiating better prices with suppliers, and optimizing resource allocation.

In further detail, to generate one or more actionable insights, the process value module 216 may include microservice architecture, augmented with generative AI (GenAI) capabilities. The microservice architecture may facilitate the adjustment or the optimization of the digital twin model leading to generation of one or more actionable insights. Specifically, the microservice architecture may break down the services offered by the process value module 216 into small, independent services. Each service may implement a specific function, such as data analysis, model generation, insight generation, or report generation. Moreover, the process value module 216 may integrate generative AI (GenAI) with natural language processing (NLP), thereby, enabling intuitive, interactive question-and-answer capabilities that enhance process understanding and decision-making. When the user submits query to interact with the back-end system 106, said query may be routed via an API gateway (not shown in the FIG. 2) to the appropriate microservice based on the requested operation in the query. Thereafter, the process value module 216 may utilize GenAI and NLP to perform inferencing and the resulting inferences may be fed back to the respective microservices for a further action or response generation.

Furthermore, to facilitate the adjustment or the optimization of the digital twin model leading to generation of one or more actionable insights, the process value module 216 may implement a plurality of lenses using specialized analytics value chain insights to objectively determine which processes are critical to business outcomes and which are not. The value chain insights may refer to a transformative approach to process improvement, distinguished by several key features. The key features may include holistic ecosystem perspective, objective analytical lenses, cross-functional dependency analysis, disruptive ideation to challenge existing processes and focus on strategic outcomes. The holistic ecosystem perspective may imply that value chain insights may provide a comprehensive view of the entire business ecosystem, integrating processes, people, technology, policies, and capabilities, thereby, enabling organizations to understand the interplay between all elements and their impact on performance. The objective analytical lenses may imply that lenses may facilitate objective evaluations of processes, thereby, identifying mission-critical processes and eliminating unnecessary ones, allowing businesses to prioritize efforts based on strategic outcomes. The cross-functional dependency analysis may imply that value chain insights may identify and analyze the interdependencies among processes across different functions. The analysis may determine relationships, foster collaboration, and break down silos, enhancing overall effectiveness. The disruptive ideation to challenge existing processes may imply, assessing whether processes are essential, or businesses can explore opportunities for optimization, automation, or elimination, driving innovation and adaptability. The focus on strategic outcomes may imply that value chain insights may align process evaluations with strategic business goals. By prioritizing desired outcomes such as, improved customer experience or faster time to market, organizations can direct efforts toward initiatives that yield measurable growth and differentiation.

The lenses may conduct both qualitative and quantitative analysis of processes across industries and functions associated with the aggregated data. The lenses may simplify complex process data into actionable insights coupled with multiple lenses, setting it apart from competitors. The lenses may be implemented using proprietary process analytics algorithms that are continuously optimized using GenAI and learnings harvested from data received from the data source 210. Specifically, said proprietary process analytics algorithms may be implemented to detect patterns, correlations, and anomalies in the aggregated data. The proprietary process analytics algorithms may include, but not limited to, time-series analysis, statistical methods and optimization algorithms. The time-series analysis may facilitate trend monitoring and anomaly detection. The statistical methods may used for computing key performance indicators (KPIs) and benchmarks. The optimization algorithms may provide actionable recommendations and identify optimal strategies. Additionally, the optimization algorithms may offer natural language feedback and actionable insights to enhance decision-making. Furthermore, a dynamic feedback loop may be provided to continuously updates model weights, parameters, and preprocessing rules. Insights from ongoing evaluations may be leveraged to drive iterative improvements, thereby ensuring the model adapts and evolves over time for enhanced performance.

In an example, the process value module 216 may utilize a variety of lenses to gain a comprehensive understanding of processes. Each lens may provide a different perspective, focusing on specific aspects such as, value of work, type of work, pain points, ERP future platform applicability and pain point categorization. Furthermore, the lenses may utilize “heat map” and “data map” visualization techniques for analyzing data. The heat maps may provide a visual representation of data density and variation, while the data maps may illustrate the flow and relationships between different data elements. The lenses with respect to value of work, utilizes the heatmap visualization to identify, for instance, level 4 activities (a specific level in a process hierarchy) that contribute most significantly to highlight the activities that directly support the organization's core purpose and strategic objectives. The lenses with respect to type of work may utilize the heatmap to categorize and visualize the nature of work being performed across various processes. The lenses with respect to type of work may further include classifying work as operational, strategic, analytical, and/or creative, etc. By visualizing the distribution of work types, organizations can gain insights into workforce composition and skill requirements. The lenses with respect to pain points may utilize the data map visualization to identify and pinpoint specific areas within processes where employees encounter challenges or difficulties in their day-to-day work. The pain points may include bottlenecks, inefficiencies, or areas requiring improvement. The lenses with respect to ERP future platform applicability may utilizes a heatmap to assess the relevance of each process to potential future enterprise resource planning (ERP) platform transformations. The lenses with respect to pain point categorization may utilize a heatmap to categorize and visualize the primary types of pain points while executing specific activities. The categorization may enable organizations to determine the root causes of pain points and prioritize improvement efforts accordingly. The effectiveness of said lenses may depend on the availability and quality of underlying data. For instance, the data source 210 may include employee surveys, process documentation, performance metrics, and other relevant information.

Further, to implement lenses, the process value module 216 may utilize multi-layered approach to analyze and understand organizational workflows. Specifically, the lenses may consolidate and segment the data to generate the one or more actionable insights. In an example, lenses (such as "Value of Work," "Type of Work," "Pain Points") may be applied to categorize and segment specific activities within the process. The process value module 216 may combine the insights from the multiple lenses to gain a deeper understanding of the value at stake and identify critical areas for improvement at the sub-process level. Thereafter, the combined insights may be used to identify specific opportunities for improvement and pinpoint the areas where intervention will have the greatest impact. For example, the overlay of "Value of Work," "Type of Work," and "Pain Points" lenses may identify activities with high value, high pain points, and a specific type of work (such as transactional). In another example, overlay of "Type of Work," "ERP Future Platform Applicability," and "Pain Points" lenses may identify transactional activities that can be supported by an ERP system and have significant pain points. The example of one or more actionable insights, derived from the lens analysis, may be as “59% of work creates no value”, “71% of work is transactional” and “68% of pain points are related to Process and Technology”.

In another example, a combination of lenses may be overlayed to gain deeper insights into organizational activities. For instance, each level 4 activity (a specific level in a process hierarchy) may be tagged with various attributes like, a specific category of type of work (for example, transactional, differentiating), value of work (for example, high, medium, low) and primary pain point (for example, technical issues, communication problems). The tagging may be based on the aggregated data from the data source 210. Specifically, the lenses “value of work” and “type of work” may be overlayed to analyze the relationship between the value of work and the type of work being performed. As a result, the insight generated may depict that 55% of activities are "transactional" in nature and do not contribute to value, thereby raising questions for the user about whether said activities could be automated or reallocated.

The lenses may utilize dynamic classification, allowing each query to follow an optimized pathway based on the type and intent, thereby improving response accuracy and efficiency. Moreover, the lenses may facilitate a responsive and efficient flow by leveraging adaptive routing by ensuring that each user query is handled with the most suitable processing path, adapting to both structured and unstructured queries.

Further, the process value module 216 may utilize an agentic architecture, facilitating the process value module 216 with a high degree of autonomy, that is, instead of following predefined rules, the process value module 216 may make independent decisions and take actions. The agentic architecture may include agents (such as AI agents), said agents may operate autonomously. For instance, the agents may perform operations such as classification logic (for example, classifying user requests), decision-making logic (for example, deciding which action to take next) and query mechanisms (for example, querying structured data for required information). Moreover, the agents may utilize support vector machines (SVM) or decision trees to classify inputs from users into predefined action categories. The agents may utilize action-planning mechanism, and based on predefined goals and decision trees, the agents may execute tasks autonomously.

In an aspect, multiple agents may share data and coordinating actions, thereby ensuring the agents function cohesively, especially in complex tasks requiring input from different areas of expertise. For example, one agent may handle user queries, while another agent may focus on data retrieval or scheduling tasks. Additionally, a communication protocol, based on multi-agent system (MAS), may be implemented, thereby enabling agents to exchange information and coordinate tasks. The agents may be equipped with feedback loops to improve over time. The agents may learn from their actions and user feedback, enhancing their decision-making capabilities and accuracy with repeated interactions. The agents may utilize techniques such as reinforcement learning (RL) to adapt based on rewards and penalties. The agents may learn from successful or failed outcomes of previous decisions to refine future actions.

The process value module 216 may track conversations and adjust responses in real time based upon using recurrent neural networks (RNNs) or long short-term memory (LSTM) models. In other words, the process value module 216 may implement models such as, RNNs or LSTM models, to manage context, ensuring the agents may retain crucial details like conversation history or user preferences across multiple interactions. Specifically, the RNNs and LSTM models may be neural networks models to process sequential data, such as text. The RNN model may include internal memory configured to store past inputs to facilitate accessing the context of previous interactions when generating a response. Thus, the RNN model may be well-suited for tasks which include sequences, such as natural language processing. Furthermore, the RNNs may process input data sequentially, passing the output of each step as input to the next. Thus, creating a loop or recurrence, allowing the network to capture dependencies between elements in the sequence. LSTMs may refer to a special type of RNN which may include a "memory cell" that can store information over long periods, enabling them to learn long-term dependencies in sequential data. In essence, by leveraging RNNs and/or LSTMs, the process value module 216 may gain insights from past interactions, maintain contextual awareness, and generate more relevant and informative responses in real time, leading to a more engaging and effective user experience.

In an example, the multiple agents may include a SQL agent, which stores and structure relationships between entities and concepts. The SQL agent may may query and reason over vast amounts of structured data. The SQL agent may facilitate data-driven decision-making, such as generating reports or providing insights. Furthermore, SQL agent may implement techniques to establish and maintain relationships between different entities (e.g., users, documents, tasks) in a database, thereby improving contextual accuracy when agents query the database. The SQL agent may utilize advanced SQL query optimization techniques to ensure faster response times when handling complex data relationships, especially under load.

The process value module 216 may further utilizes techniques such as NLP to interpret user language, enable reasoning and act based on user instructions, queries, and contextual information. The agentic architecture may make autonomous decisions by considering various factors, including, but not limited to, task priority, past interactions and real-time context. Herein, the task priority may refer to assessing the relative importance of different tasks and prioritizing said tasks accordingly. The past interactions may refer to learning from previous interactions with users and adapting to users’ behavior accordingly. The real-time context may refer to considering the current context, such as user preferences, available resources, and ongoing activities, to make informed decisions.

The utilization of NLP by process value module 216 may further utilize language models to determine user intents and extract entities. The NLP technique may leverage the context by tracking conversation history and user preferences, refining the responses dynamically based on previous learning from the conversation. Moreover, a model database may be provided, said model database may include one or more Large Language Models (LLMs) (also be referenced to as Generative Artificial Intelligence (GAI)) models, foundation models, and/or the like). In an implementation, the LLMs may include pre-trained LLMs or generated LLMs. The pre-trained LLMs may be general-purpose GAI models like large deep learning neural networks, which may be trained using a broad range of generalized and unlabeled training data to perform one or more tasks, such as, human computer interactions (e.g., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or Artificial Intelligence (AI) models.

In an aspect, the process value module 216 may implement a technique, such as, kubernetes auto-scaling, in order to scale microservices during high load to ensure optimal performance. The scaling of microservices may facilitate handling of traffic surges, such as during large-scale deployments or performance testing. For example, the kubernetes horizontal pod auto scaler (HPA) may be used to dynamically adjust the number of running pods. The HPA is based upon metrics like CPU usage, memory load, and request rates.

Furthermore, the process value module 216 may use AI models to predict traffic patterns and proactively adjust resources to avoid bottlenecks. The predictive scaling may ensure that the back-end system is always prepared for spikes in demand. The AI model may use time series forecasting to analyze historical load patterns and predict future resource needs. The AI model may further include anomaly detection techniques to identify unexpected load spikes or unusual behavior patterns, triggering additional scaling or alerting system admins.

Moreover, the one or more insights may be generated to provide one or more of suggestions for improvements, potential risks, areas of efficiency gains, performance metrics, trends, and/or key process indicators (KPIs). In further detail, potential risks may include risk associated with current processes or proposed changes for example, operational risks, financial risks, and reputational risks. The areas of efficiency gains may include specific areas within the organization where significant efficiency gains may be achieved, for example, identifying and eliminating waste in processes, streamlining workflows, and improving resource utilization. The performance metrics may include key performance indicators (KPIs) relevant to the organization's objectives. The KPIs may be used to track progress, measure performance, and identify areas for improvement. Suggestion on trend may include analyzing historical data to identify trends in process performance, market conditions, and other relevant factors, thereby anticipating future challenges and opportunities.

The one or more insights may be generated as summaries, reports, or documents, and the one or more insights provide an explanation for process changes or decision rationales. Specifically, summaries may include concise overviews of key findings and recommendations, highlighting the most important takeaways. The reports may include in-depth analysis and recommendations, including data visualizations, charts, and graphs to illustrate key findings and support decision-making. The documents may include the entire analysis process, including data sources, methodology, findings, and recommendations.

The data hub 218 may be a centralized data repository where all input from data source 210 may be stored for further processing. The data hub 218 may include third-party and proprietary data, data models, process management benchmarks, and knowledge services. The data hub 218 may process the aggregated data from the data source 210. The processing by the data hub 218 may include, but not limited to, transformations (for example data cleaning, data enrichment and/or data normalization) and validations. The data hub 218 may implement validation rules to ensure data quality and integrity. The validation may include checking for data type consistency, completeness, and adherence to predefined business rules. The data hub 218 may store processed data in a relational database management system (RDBMS). The relational database management system may provide structured storage, efficient querying capabilities, and support for complex relationships between different data entities. Additionally, the data hub 218 may also support storing data in secure flat files. The flat files may be used for specific data types, such as log files, or for archiving purposes. The flat file can be more efficient for certain types of data and can be easily transferred. In essence, the data hub 218 may prepare and store data in a format that is suitable for analysis and consumption by other components within the back-end system 106.

Furthermore, the data hub 218 may consolidate and segment the data to generate the one or more actionable insights (by the process value module 216). The one or more insights may be generated based upon a root cause analysis performed based upon historical data and model analysis. The historical data may include but not limited to, detailed records of past process instances (for example, timestamps, resource assignments, event logs, or the like), key performance indicators (KPIs) (for example, cycle times, throughput, error rates, or the like), records of past incidents, failures, or deviations from expected behavior. In further detail, the root cause analysis may include applying multiple lenses (for example, value of work, type of work, pain points, resource utilization, technology dependency) to the historical data to gain different perspectives on the process. Each lens may provide insights into specific aspects of the process, such as the value it generates, the type of work involved, the presence of pain points, and the resources consumed. Thereafter, visualization techniques (for instance, heatmaps and data maps) may be used to represent the data and identify patterns and anomalies. Moreover, the relationships between different lenses may be analyzed to identify potential root causes. For example, a strong correlation may be identified between high pain points, low value activities, and specific types of work. Based on the analysis, the system may generate hypotheses about the root causes of observed issues.

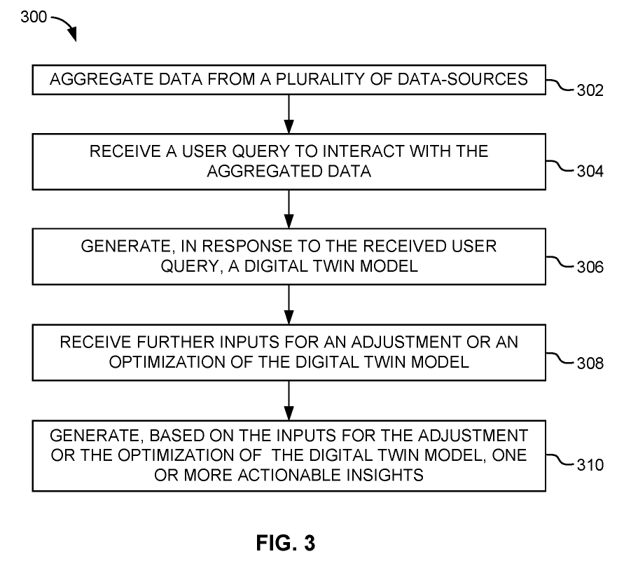

FIG. 3 illustrates the flow diagram of an example method 300 implemented by the back-end system 106, to generate actionable insights during process assessment, in accordance with implementations of the present disclosure.

The method 300 may aggregate 302 data from the plurality of data-sources (in the data source 210). Herin, the data may be associated with one or more of process mining, market analysis capabilities, and/or process management.

The method 300 may receive 304 the user query to interact with the aggregated data. Specifically, the back-end system 106 may enable user to submit the query via user interface 208. Specifically, the user query associated may be a natural language processing query and associated with data exploration and process management. Herein, the process management may include a structure, performance, and a bottleneck of a process.

The method 300 may include generating 306, in response to the received user query, the digital twin model enabling visualization and simulation of organizational changes prior to implementation of the organizational changes. The twin module 214, to generate the digital twin model, may prompt and receive user input about the plurality of factors. Further, the twin module 214 may weigh, using the autonomy algorithm, the plurality of factors including a task priority, past interactions, and/or real-time context.

The method 300 may include receiving 308 further inputs, based upon simulation inputs for the organizational changes, for an adjustment or an optimization of the digital twin model.

The method 300 may include generating 310, based on the inputs for the adjustment or the optimization of the digital twin model, one or more actionable insights directed to improve efficiency or operational effectiveness. The the one or more actionable insights may include process management insights, an operating model, an organizational design, a market analysis, and a spend analysis. Specifically, the one or more insights may be generated to provide one or more of: suggestions for improvements, potential risks, areas of efficiency gains, performance metrics, trends, and/or key process indicators (KPIs). Further, the one or more insights may be generated as summaries, reports, or documents, and the one or more insights may provide an explanation for process changes or decision rationales.

Implementations of the present disclosure provides technical solutions to multiple technical problems that arise in the context of generating actionable insights during process assessment. For example, in the present disclosure, the process value module 216 may implement lenses, said lenses may overlay quantitative and qualitative data from multiple sources (for example, workshops, surveys, interviews, client data) to quantify costs, recognize impediments, and access effectiveness. Users may leverage said lenses to understand the relationships across various aspects of a process. The process value module 216 may identify performance improvement opportunities further realized through the cross-correlation and creation of lenses that enable the quantification of the relationship between processes, workforce, and technology, leading to enabling data-driven prioritization of improvement opportunities. The lenses may generate valuable insights that focus on rapidly improving quantitative and qualitative impediments across processes, technology and data, workforce, operating model, and functional capabilities. Through digital activity crowd sourcing from thousands of employees, the back-end system 106 may gather a common point of reference to respond to open and closed-ended questions, which traditional surveys fail to capture. With twin module 214, the back-end system 106 may identify common themes and pain points to highlight recurring issues across the organization. The twin module 214 may analyze and quantify the intricate relationships between various elements of operating ecosystem.

Moreover, the present disclosure includes agents capable of making autonomous decisions in dynamic, unpredictable environments, while ensuring accuracy, efficiency, and alignment with user goals. Hierarchical decision trees may be employed where agents make high-level decisions first and progressively refine their actions, allowing agents to respond to real-time changes in a modular, prioritized manner. Moreover, in the present disclosure reinforcement learning (RL) may be integrated into the decision-making logic, enabling agents to improve through trial and error. Agents may adapt their behavior based on historical interactions, optimizing decision-making pathways over time. The hierarchical design of decision trees, coupled with real-time reinforcement learning, provides a unique, adaptive system that ensures agents make the appropriate decisions in real-time across different scenarios.

A combination of machine learning models and syntactic analysis to convert user input into optimized SQL queries may be implemented in the present disclosure. Additionally, query optimization techniques may be used to reduce overhead and improve performance. The present disclosure may include handling multiple user inputs and decision pathways while maintaining coherency across agent actions, especially when external data changes rapidly. The integration of NLP with semantic understanding for SQL query generation in real-time ensures both performance and accuracy, which is not typically seen in traditional query-building systems.

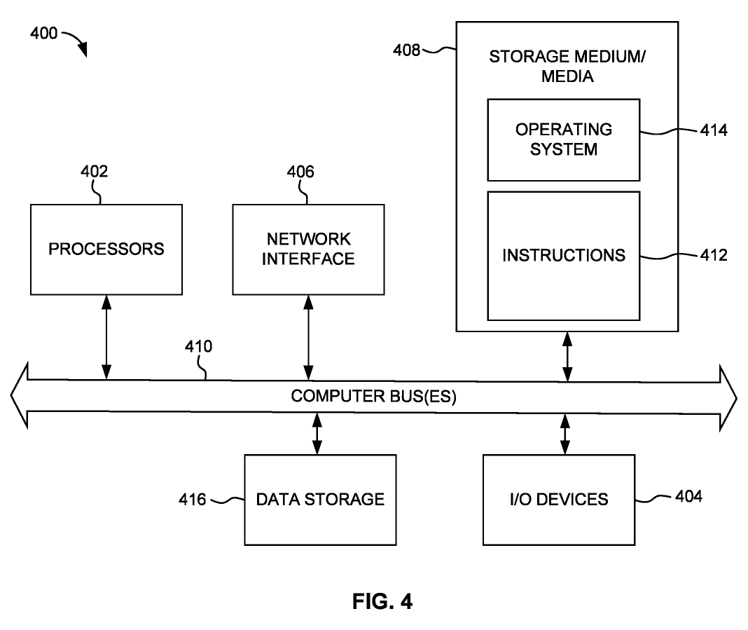

FIG. 4 illustrates a computer system 400 that may be used to implement the system 106 for generating actionable insights during process assessment, in accordance with implementations of the present disclosure. More particularly, computing machines such as desktops, laptops, smartphones, tablets, and wearables which may be used to implement the tasks that may have the structure of the computer system 400. The computer system 400 may include additional components not shown and that some of the process components described may be removed and/or modified. In another example, a computer system 400 may be deployed on external-cloud platforms such as cloud, internal corporate cloud computing clusters, organizational computing resources, and/or the like.

The computer system 400 includes processor(s) 402, such as a central processing unit, ASIC or another type of processing circuit, input/output devices 404, such as a display, mouse keyboard, etc., a network interface 406, such as a Local Area Network (LAN), a wireless 802.11x LAN, a 3G or 4G mobile WAN or a WiMax WAN, and a computer-readable medium 408. Each of these components may be operatively coupled to a bus 410. The computer-readable medium 408 may be any suitable medium that participates in providing instructions to the processor(s) 402 for execution. For example, the computer-readable medium 408 may be non-transitory or non-volatile medium, such as a magnetic disk or solid-state non-volatile memory or volatile medium such as RAM. The instructions or modules stored on the computer-readable medium 408 may include machine-readable instructions 412 executed by the processor(s) 402 that cause the processor(s) 402 to perform the methods and functions of the system for generating actionable insights during process assessment.

The system may be implemented as software stored on a non-transitory processor-readable medium and executed by the processors 402. For example, the computer-readable medium 408 may store an operating system 414, such as MAC OS, MS WINDOWS, UNIX, or LINUX, and code for the system. The operating system 414 may be multi-user, multiprocessing, multitasking, multithreading, real-time, and the like. For example, during runtime, the operating system 414 is running and the code for the system is executed by the processor(s) 402.

The computer system 400 may include a data storage 416, which may include non-volatile data storage. The data storage 416 stores any data used or generated by the system.

The network interface 406 connects the computer system 400 to internal systems for example, via a LAN. Also, the network interface 406 may connect the computer system 400 to the Internet. For example, the computer system 400 may connect to web browsers and other external applications and systems via the network interface 406.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:at least one memory configured to store machine executable instructions; andat least one processor communicatively coupled with the at least one memory and configured to execute the machine executable instructions to:programmatically access and retrieve data stored in a plurality of data sources and consolidate the data from a diverse range of external platforms to obtain aggregated data, wherein theretrieved data isassociated with one or more of process mining, market analysis capabilities, and/or process management;receive a user query to interact with the aggregated data;generate, in response to the received user query, a digital twin model enabling visualization and simulation of organizational changes prior to implementation of the organizational changes;apply a plurality of analytical lenses to the aggregated data, each analytical lens being configured to perform a different quantitative or qualitative analysis including at least one of value-of-work analysis, type-of-work classification, and pain-point identification;based upon simulation inputs for the organizational changes, receive inputs for one of an adjustment and an optimization of the digital twin model; andgenerate, based on the inputs for one of the adjustment and the optimization of the digital twin model, one or more actionable insights directed to improve efficiency or operational effectiveness, wherein the plurality of analytical lenses are used to consolidate and segment the aggregated data to generate the one or more actionable insights.

2. The system of claim 1, wherein the one or more actionable insights include process management insights, an operating model, an organizational design, a market analysis, and a spend analysis.

3. (canceled)

4. The system of claim 1, wherein the user query associated for data exploration and process management is a natural language processing query and associated with data exploration and process management, and wherein the process management including a structure, performance, and a bottleneck of a process.

5. The system of claim 1, wherein the one or more actionable insights are generated to provide one or more of: suggestions for improvements, potential risks, areas of efficiency gains, performance metrics, trends, and key process indicators (KPIs).

6. The system of claim 1, wherein the one or more actionable insights are generated based upon a root cause analysis performed based upon historical data and model analysis.

7. The system of claim 1, wherein the one or more actionable insights are generated as summaries, reports, and documents, and wherein the one or more actionable insights provide an explanation for process changes or decision rationales.

8. The system of claim 1, wherein to generate the digital twin model, the at least one processor is further configured to execute the machine executable instructions to:prompt and receive user input about a plurality of factors; andweigh, using an autonomy algorithm, the plurality of factors including a task priority, past interactions, and/or real-time context.

9. The system of claim 8, wherein the digital twin model is based on a reinforcement learning model.

10. The system of claim 1, wherein the at least one processor is further configured to execute the machine executable instructions to: track conversations and adjust responses in real time based using recurrent neural networks (RNNs) or long short-term memory (LSTM) models.

11. A computer-implemented method comprising:programmatically accessing and retrieving data stored in a plurality of data sources and consolidate the data from a diverse range of external platforms to obtain aggregated data, wherein theretrieved data isassociated with one or more of process mining, market analysis capabilities, and/or process management;
receiving a user query to interact with the aggregated data;
generating, in response to the received user query, a digital twin model enabling visualization and simulation of organizational changes prior to implementation of the organizational changes;
apply a plurality of analytical lenses to the aggregated data, each analytical lens being configured to perform a different quantitative or qualitative analysis including at least one of value- of-work analysis, type-of-work classification, and pain-point identification;
based upon simulation inputs for the organizational changes, receiving inputs for an adjustment or an optimization of the digital twin model; and
generating, based on the inputs for one of the adjustment and the optimization of the digital twin model, one or more actionable insights directed to improve efficiency or operational effectiveness, wherein the plurality of analytical lenses are used to consolidate and segment the aggregated data to generate the one or more actionable insights.

12. The computer-implemented method of claim 11 wherein the one or more actionable insights include process management insights, an operating model, an organizational design, a market analysis, and a spend analysis.

13. (canceled)

14. The computer-implemented method of claim 11, wherein the user query associated for data exploration and process management is a natural language processing query and associated with data exploration and process management, and wherein the process management including a structure, performance, and a bottleneck of a process.

15. The computer-implemented method of claim 11 wherein the one or more actionable insights are generated to provide one or more of: suggestions for improvements,
potential risks, areas of efficiency gains, performance metrics, trends, and key process indicators (KPIs).

16. The computer-implemented method of claim 11 wherein the one or more actionable insights are generated based upon a root cause analysis performed based upon historical data and model analysis.

17. The computer-implemented method of claim 11 wherein the one or more actionable insights are generated as summaries, reports, and documents, and wherein the one or more actionable insights provide an explanation for process changes or decision rationales.

18. The computer-implemented method of claim 11, wherein generating the digital twin model comprises:prompting and receiving user input about a plurality of factors; andweighing, using an autonomy algorithm, the plurality of factors including a task priority, past interactions, and/or real-time context,wherein the digital twin model is based on a reinforcement learning model.

19. The computer-implemented method of claim 11 further comprising tracking conversations and adjusting responses in real time based using recurrent neural networks (RNNs) or long short-term memory (LSTM) models.

20. At least one non-transitory computer-readable medium (CRM) storing machine executable instructions thereon, which, when executed by at least one processor of a computing device, cause the computing device to:programmatically access and retrieve data stored in a plurality of data sources and consolidate the data from a diverse range of external platforms to obtain aggregated data , wherein the retrieved data isassociated with one or more of process mining, market analysis capabilities, and/or process management;receive a user query to interact with the aggregated data;
generate, in response to the received user query, a digital twin model enabling visualization and simulation of organizational changes prior to implementation of the organizational changes;apply a plurality of analytical lenses to the aggregated data, each analytical lens being configured to perform a different quantitative or qualitative analysis including at learst one of value-of-work analysis, type-of-work classification, and pain-point identification;based upon simulation inputs for the organizational changes, receive inputs for an adjustment or an optimization of the digital twin model; andgenerate, based on the inputs for one of the adjustment and the optimization of the digital twin model, one or more actionable insights directed to improve efficiency or operational effectiveness, wherein the plurality of analytical lenses are used to consolidate and segment the aggregated data to generate the one or more actionable insights.

21. The system of claim 1, wherein applying the analytical lenses on the aggregated data comprises utilizing visualization techniques that include heat mapping and data mapping for analyzing data.

22. The computer-implemented method of claim 11, wherein applying the analytical lenses on the aggregated data comprises utilizing visualization techniques that include heat mapping and data mapping for analyzing data.
